(19) United States
(12) Patent Application Publication
(10) Pub. No.: US 2026/0073572 A1
(43) Pub. Date: Mar. 12, 2026

(54) 3D GAUSSIAN SPLATTING DATA COMPRESSION

(71) Applicants: SONY GROUP CORPORATION, Tokyo (JP); Sony Corporation of America, New York, NY (US)

(72) Inventors: Shashank Nelamangala Sridhara, Los Angeles, CA (US); Alexandre Zaghetto, San Jose, CA (US); Danillo Graziosi, Flagstaff, AZ (US); Ali Tabatabai, Cupertino, CA (US)

(21) Appl. No.: 19/299,682

(22) Filed: Aug. 14, 2025

Related U.S. Application Data
(60) Provisional application No. 63/688,356, filed on Aug. 29, 2024.

(51) Int. Cl. G06T 9/00; G06T 9/40

(52) U.S. Cl. CPC G06T 9/001; G06T 9/40

(57) ABSTRACT

Post training compression of 3DGS data is agnostic to training in a traditional signal compression perspective. Gaussian parameters are treated as signals. Pre-processing and transform coding techniques are used to compress the signals effectively. Firstly, lossless/lossy compression is performed on 3DGS geometry (positions, scales, rotations) using a point cloud coding-based (e.g., G-PCC, GeS) framework. Positions are compressed using occupancy tree coding. Scales and rotations are encoded as attributes using transform coding. The widely used block-based graph Fourier transform (GFT) is used to compress the attributes (base colors, spherical harmonic coefficients and opacities). In addition, a graph construction strategy is used for 3DGS data that computes the edge weights based on similarity (or dissimilarity) between the 3D Gaussian distributions using KL-divergence. Alternatively, positions can be encoded using occupancy tree (e.g., G-PCC, GeS) or AI-based PCC methods, and any subset of Gaussian parameters or the transformed coefficients of Gaussian parameters can be mapped into 2D frames and encoded by video coders.

### CROSS-REFERENCE TO RELATED APPLICATION(S)

This application claims priority under 35 U.S.C. § 119 (e) of the U.S. Provisional Patent Application Ser. No. 63/688,356, filed Aug. 29, 2024 and titled, “3D GAUSSIAN SPLATTING DATA COMPRESSION,” which is hereby incorporated by reference in its entirety for all purposes.

### FIELD OF THE INVENTION

The present invention relates to 3D Gaussian splats. More specifically, the present invention relates to 3D Gaussian splatting data compression.

### BACKGROUND OF THE INVENTION

3D Gaussian Splatting (3DGS) has emerged as an efficient method for novel view synthesis from a sparse set of images. The scene represented by 3DGS can be rendered at high speed (>100 fps) compared to its precursors—NeRF, Plenoxels, and others. Due to faster training and high-quality rendering, 3DGS data is expected to grow significantly in the near future. However, the optimized 3DGS includes millions of Gaussian primitives and uses gigabytes of memory to store.

Existing works on 3DGS compression focus on optimizing the training process to obtain a lightweight model by pruning the redundant Gaussians. In addition, the existing methods treat spherical harmonic coefficients as 48D vectors from a machine-learning perspective and apply clustering/vector quantization. Adaptively truncating the SH coefficients to a lower order has also been explored towards compression.

### SUMMARY OF THE INVENTION

Post training compression of 3DGS data is agnostic to training in a traditional signal compression perspective. Gaussian parameters are treated as signals. Pre-processing and transform coding techniques are used to compress the signals effectively. Firstly, lossless/lossy compression is performed on 3DGS geometry (positions, scales, rotations) using a point cloud coding-based (e.g., G-PCC, GeS) framework. Positions are compressed using occupancy tree coding. Scales and rotations are encoded as attributes using transform coding. The widely used block-based graph Fourier transform (GFT) is used to compress the attributes (spherical harmonic coefficients and opacities). In addition, a graph construction strategy is used for 3DGS data that computes the edge weights based on similarity (or dissimilarity) between the 3D Gaussian distributions using KL-divergence.

In one aspect, a method programmed in a non-transitory memory of a device comprises performing compression on a three-dimensional Gaussian splat (3DGS) geometry using a geometry-based point cloud compression (G-PCC, GeS) framework, encoding scales and rotations as attributes using transform coding, compressing positions using occupancy tree encoding, implementing block-based graph Fourier transform (GFT) to compress the attributes and computing the edge weights based on a similarity between the 3D gaussian distributions using KL-divergence. The 3DGS geometry includes positions, the scales, and the rotations. The attributes include base colors, spherical harmonics coefficients and opacities. The compression is lossless. Alternatively, the compression is lossy. The method comprises pre-processing the 3DGS geometry including performing color space conversion and spherical harmonics coefficients reduction.

In another aspect, an apparatus comprises a non-transitory memory configured for storing an application, the application configured for: performing compression on a three-dimensional Gaussian splat (3DGS) geometry using a geometry-based point cloud compression (G-PCC) framework, encoding scales and rotations as attributes using transform coding, compressing positions using occupancy tree encoding, implementing block-based graph Fourier transform (GFT) to compress the attributes and computing the edge weights based on a similarity between the 3D gaussian distributions using KL-divergence and a processor configured for processing the application. The 3DGS geometry includes positions, the scales, and the rotations. The attributes include base colors, spherical harmonics coefficients and opacities. The compression is lossless. Alternatively, the compression is lossy. The application is further configured for: pre-processing the 3DGS geometry including performing color space conversion and spherical harmonics coefficients reduction.

In another aspect, a system comprises an encoder configured for: performing compression on a three-dimensional Gaussian splat (3DGS) geometry using a geometry-based point cloud compression (G-PCC) framework, encoding scales and rotations as attributes using transform coding, compressing positions using occupancy tree encoding, implementing block-based graph Fourier transform (GFT) to compress the attributes and computing the edge weights based on a similarity between the 3D gaussian distributions using KL-divergence and a decoder configured for: decoding the compressed Gaussian splat. The 3DGS geometry includes positions, the scales, and the rotations. The attributes include base colors, spherical harmonics coefficients and opacities. The compression is lossless. Alternatively, the compression is lossy. The system is further configured for pre-processing the 3DGS geometry including performing color space conversion and spherical harmonics coefficients reduction.

In yet another aspect, a method programmed in a non-transitory memory of a device comprises organizing parameters of a plurality of ordered points, storing the plurality of ordered points in a two-dimensional structure, wherein each point of the plurality of ordered points is in a column, and attribute information is stored in each row and processing the plurality of ordered points and the corresponding attribute information using a video coding scheme, processing position information using a point cloud coding-based scheme, wherein the processed attribute information and position information generates a Gaussian splat bitstream. The plurality of ordered points are ordered in Morton order. The attribute information comprises scales, rotations, DCs, spherical harmonics coefficients, and opacity. Alternatively, positions can be encoded using occupancy tree (e.g., G-PCC, GeS) or AI-based PCC methods, and any subset of Gaussian parameters or the transformed coefficients of Gaussian parameters can be mapped into 2D frames and encoded by video coders. The video coding scheme is selected from Advanced Video Coding, High Efficiency Video Coding or Versatile Video Coding. The point cloud coding-based scheme is selected from geometry-based point cloud compression, video-based point cloud compression or artificial intelligence-based point cloud compression.

### BRIEF DESCRIPTION OF THE DRAWINGS

FIG. 1 shows a diagram of the context where the proposed encoding/decoding solution is placed according to some embodiments.

FIG. 2 shows a diagram of an alternative 3DGS parameters interpretation according to some embodiments.

FIG. 3 shows a diagram of pre-processing according to some embodiments.

FIGS. 4A-D show tables and plots of results of pre-processing according to some embodiments.

FIG. 5 shows a plot of determining an optimal xyz position bit-depth for Gaussian splat according to some embodiments.

FIG. 6 shows a diagram of a general codec framework according to some embodiments.

FIG. 7 shows a diagram of a geometry encoder and an attribute encoder according to some embodiments.

FIG. 8 shows a diagram of attribute coding according to some embodiments.

FIG. 9 shows a diagram of reducing the number of SH coefficients according to some embodiments.

FIG. 10 shows a diagram of transforms according to some embodiments.

FIG. 11 illustrates a diagram of an image-based approach according to some embodiments.

FIG. 12 illustrates a diagram of an image-based approach according to some embodiments.

FIG. 13 illustrates a diagram of a 3D Gaussian-based method of distortion evaluation according to some embodiments.

FIG. 14 illustrates a diagram of a 3D Gaussian-based method of evaluation according to some embodiments.

FIG. 15 shows a block diagram of an exemplary computing device configured to implement the 3D Gaussian splatting data compression method according to some embodiments.

### DETAILED DESCRIPTION OF THE PREFERRED EMBODIMENT

Point clouds are three-dimensional (3D) representations of the surfaces of objects or environments. Point clouds are composed of a collection of individual data points, each with a set of coordinates in a 3D Cartesian coordinate system xyz. In addition to xyz positions, point clouds can include additional attributes, such as color, reflectance and normals.

MPEG Point Cloud Compression Standards Compression of point cloud data is important for several reasons, such as storage and transmission efficiency.

Video-based Point Cloud Compression (V-PCC) and Geometry-based Point Cloud Compression (G-PCC) are part of MPEG's efforts to standardize point cloud compression techniques.

V-PCC converts the point cloud data from 3D to 2D, which is then coded by 2D video encoders, and G-PCC encodes the content directly in 3D space.

Originally, the first edition of G-PCC targeted use cases involving: static surface point clouds from sparse to solid, particularly in the immersive applications context; multi-frame/fused LiDAR point clouds, in the automotive application context; but it lacked tools for inter-frame compression.

V-PCC targets the use case involving: dynamic solid point clouds in the immersive applications context; and more recently, MPEG has been working towards an enhanced edition of G-PCC with the aim of expanding its applicability to dynamic point clouds, particularly in the context of automative applications, and sparse point clouds in general. This expansion includes the incorporation of additional tools for inter-frame coding of geometry and attributes.

Specifically, the development of tools for dynamic “solid” point clouds, which were previously a focus of V-PCC, motivated G-PCC experts to collaborate on a separate project known as Geometry-based point cloud coding for solid objects (GeS).

### 3D Gaussian Splatting

Gaussian splatting is a technique used in computer graphics for efficiently representing and rendering 3D scenes. The method allows for the interpolation and reconstruction of scene information across viewpoints, enabling the rendering of novel views in real-time. Similar to point clouds, Gaussian splats data includes a collection of xyz positions and associated attributes. In point clouds, the attributes represent the point properties at precise xyz locations. In contrast, with Gaussian splats, the attributes represent 3D Gaussians centered at xyz positions.

The approach facilitates view-dependent rendering but includes additional attribute information per Gaussian, including rotation, scales, view-dependent color coefficients (base colors or DCs or diffuse spherical harmonics, and specular spherical harmonics), and opacity values.

### 3D Gaussian Splatting Data Structure

3DGS can be interpreted as point clouds with extra attributes.

The position defines where the Gaussian splat is located in 3D space. The scale determines the size or extent of the splat in different directions. The rotation specifies the orientation of the splat in space. The Diffuse Spherical Harmonics (or base colors or DCs) set the underlying colors of the splat, contributing to its visual characteristics. The Specular Spherical Harmonics (or SH) describe how light interacts with the surface of the splat, influencing shading and color variation based on direction. The opacity controls the transparency of the splat, affecting its visibility and blending with other elements.

### View-dependent Effects of Gaussian Splatting Spherical Harmonics

$$color\_rgb ( θ , Φ ) = \{ \begin{matrix}R ( θ , Φ ) \approx {\sum }_{l = 0}^{k} {\sum }_{m = - l}^{l} {c}_{l}^{m} ( r ) {Z}_{l}^{m} ( θ , ϕ ) \\ G ( θ , Φ ) \approx {\sum }_{l = 0}^{k} {\sum }_{m = - l}^{l} {c}_{l}^{m} ( g ) {Z}_{l}^{m} ( θ , ϕ ) \\ B ( θ , Φ ) \approx {\sum }_{l = 0}^{k} {\sum }_{m = - l}^{l} {c}_{l}^{m} ( b ) {Z}_{l}^{m} ( θ , ϕ )\end{matrix}$$

color_rgb (θ, φ)=>view-dependent color given by a viewing direction (θ, φ).

Z_1 \hat{ }m (θ, φ) are the spherical harmonic (SH) basis functions, where 1 and m are order and degree of the function.

C_1 \hat{ }m are the SH coefficients.

A linear combination of the coefficients and basis functions result in view dependent color.

Each color channel has 16 coefficients for order 3 representation.

### 3D Gaussian Splats Compression

Compression of gaussian splats for storage and transmission efficiency is important due to its substantial amount of data.

### Training-Based Model Simplification

Existing work on 3DGS compression focuses on optimizing the training process to obtain a lightweight model by pruning the redundant Gaussians.

In addition, the existing methods treat spherical harmonic coefficients as a 48D vector from a machine learning perspective and apply clustering/vector quantization.

Adaptively truncating the SH coefficients to a lower-order is able to be used for compression.

### Traditional Coding

Graph-based methods have been widely used to compress 3D point clouds which comes under traditional transform coding.

G-PCC is one of MPEG's standardizations to encode 3D point clouds, which is based on transform coding.

### G-PCC-Based Compression Scheme

The similarities between point clouds and Gaussian splats raise questions about how well current point-cloud compression approaches, such as G-PCC, can compress Gaussian splitting data.

Recently, MPEG explorations on Gaussian splat coding show how to leverage existing G-PCC framework to compress 3DGS.

The positions are losslessly encoded using occupancy tree encoding.

The rest of the parameters—scales (3), rotations (4), opacities (1), base colors (3) and SH coefficients (45) are encoded using RAHT by treating all 56 parameters as reflectance.

For pre-processing, each Gaussian parameter is quantized before encoded.

### 3D Gaussian Splatting Model Training

Image/video capture: the system captures a 2D images/videos of an object or scene with the view-points required for the later 3D representation.

Training data preparation: 3D structures are estimated from a series of 2D images taken from different view-points. One example is the Structure-from-motion (SfM) technique, which includes feature extraction, feature matching, camera pose estimation, sparse point cloud reconstruction and bundle adjustment.

Gaussian Splatting (GS) model training: involves optimizing the model of a scene by fitting a set of 3D Gaussian functions to a sparse set of input points, typically using a gradient-based approach to refine the Gaussian parameters for better rendering.

GS view-dependent rendering: generating a visual image or animation from a model, where the appearance of an object or scene changes depending on the direction from which it is observed.

### 3D Gaussian Splatting Data Compression Method

The method described herein provides efficient compression of 3DGS data for storage and transmission of immersive media.

Contrary to all simplification methods, the focus described herein is on post-training compression of 3DGS data that is agnostic to training in a traditional signal compression perspective.

Gaussian parameters are treated as signals, and pre-processing and coding techniques are used to compress them effectively.

Firstly, lossless or lossy compression is performed on 3DGS geometry (positions, scales, rotations) using the G-PCC framework. Positions are compressed using occupancy tree encoding.

Scales and rotations are encoded as G-PCC point cloud attributes using transform coding.

The widely used block-based graph Fourier transform (GFT) is used to compress the attributes (base colors, SH coefficients and opacities).

In addition, a graph construction strategy for 3DGS data that computes the edge weights based on similarity (or dissimilarity) between the 3D gaussian distributions using Kullback-Leibler (KL)-divergence is used.

Gaussian splatting-based distortion metrics are used-one that uses that uses KL-divergence, another that uses Wasserstein distance, and another one that applies sampling, both in the 3D Gaussian splatting domain.

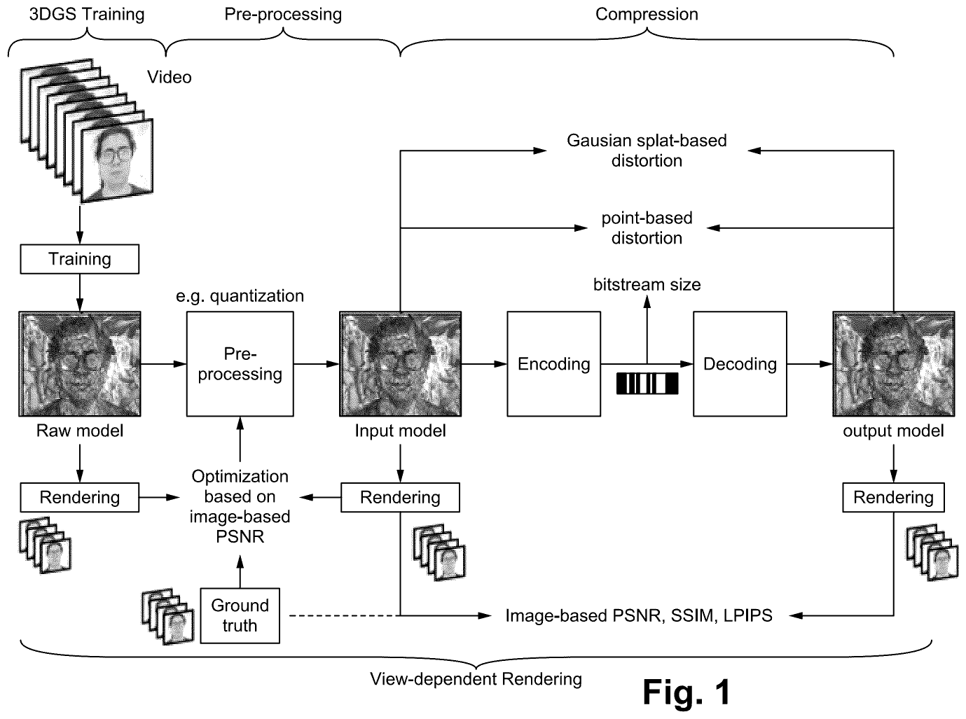

FIG. 1 shows the context where the proposed encoding/decoding solution is placed according to some embodiments. Content (e.g., images/videos) is acquired. The content is used to perform 3DGS training. The 3DGS training results in a Gaussian splat raw model. Pre-processing is performed on the raw model. The pre-processing is able to include quantization and other steps. The pre-processing results in an input model.

The input model is encoded, compressed and decoded, resulting in an output model, which is able to be rendered and displayed.

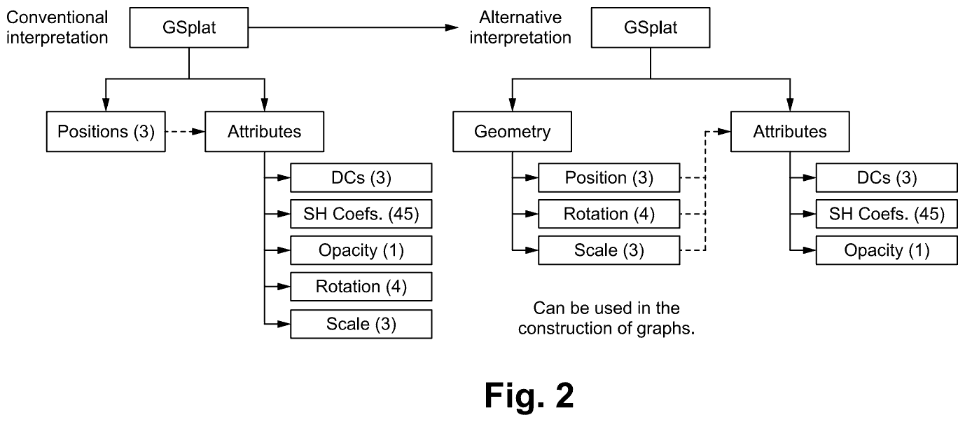

FIG. 2 shows a diagram of an alternative 3DGS parameters interpretation according to some embodiments. Since the position, scale, and rotation parameters are related to the spatial properties of the Gaussian splats, and can be used in the construction of graphs; and the base colors, spherical harmonics and opacity are connected to the texture and appearance of the Gaussian splats, the GS parameters can be reinterpreted as shown.

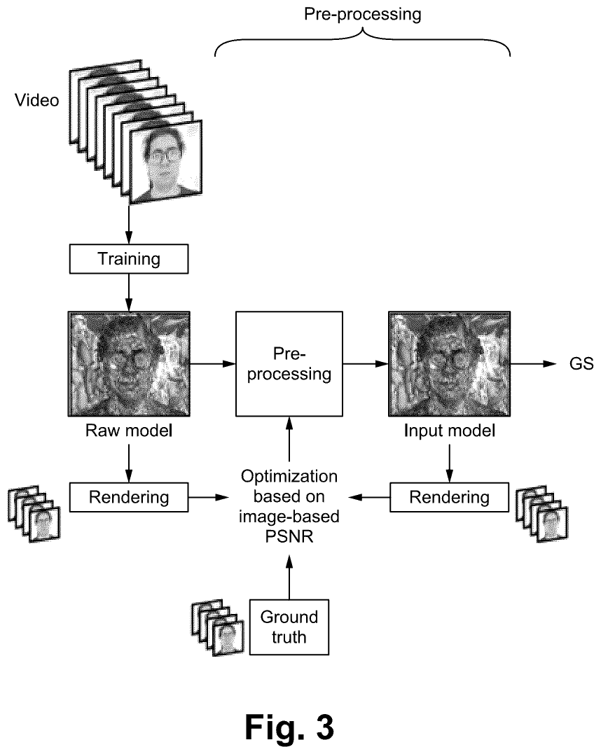

FIG. 3 shows a diagram of pre-processing according to some embodiments. The pre-processing step includes preparing the trained model (raw model) for compression, by generating the input to the 3DGS encoder (input model). The pre-processing step includes multiple procedures, such as gaussian pruning, model retraining, and others, and the step can affect geometry or attribute data. An implementation utilizing voxelization of positions and integer representation of scales and rotation is described. The optimal position, rotation and scales bit-depth for rendering quality preservation are determined.

As described, videos or images are received and used for training to generate a raw model. Some of the images are selected and used for ground truths in the optimization process.

The procedure for xyz positions is described, but the same method can be applied to scales and rotation sequentially. The xyz positions of the Gaussian splats are quantized using different bit-depths, and the average Peak Signal-to-Noise Ratio (PSNR), Structural Similarity Index Measure (SSIM) and Learned Perceptual Image Patch Similarity (LPIPS) are computed for multiple rendered views against the ground truth. In some embodiments, only one measure is calculated such as the PSNR. Lossless G-PCC geometry coding is applied to the quantized geometry, and the number of bits per point is calculated. The rate-distortion behavior is also analyzed.

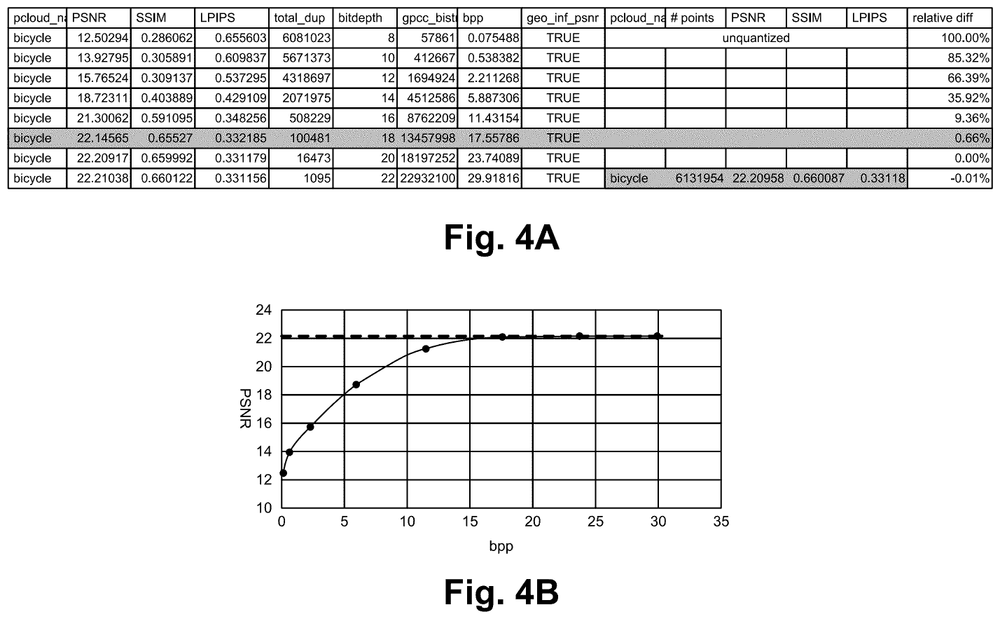

FIGS. 4A-D show tables and plots of results of pre-processing according to some embodiments. A Gaussian splat is selected to be encoded. The xyz positions are quantized with different bit depths (e.g., 8, 10, 12, 14, 16, 18, 20 and 22). For each of the bit depths, there is a reconstructed Gaussian splat with a different quality. After a specific bit depth, the PSNR curve flattens, and there is no improvement even as the bit depth is increased. A bit depth threshold is able to be established by determining at what bit depth there is no further improvement in PSNR or another metric. In some embodiments, the bit depth threshold is learned via machine learning/artificial intelligence. For example, a machine tries different bit depths until the relative difference is below a relative difference threshold (e.g., 1%), and when the bit depth results in a relative difference below the relative difference threshold, that bit depth is the bit depth threshold used (e.g., 18). In some embodiments, the threshold is a user-defined parameter.

A relative difference D is calculated for each simulation point:

$$D = 100 \times \frac{{PSNR}_{u q} - {PSNR}_{b d}}{{PSNR}_{u q} - {PSNR}_{bdmin}} \%$$

PSNR_{uq} is the maximum PSNR, obtained from the rendering with the unquantized geometry quantization.
PSNR_{bd} is the PSNR obtained using a specific bit-depth.
PSNR_{bdmin} is the PSNR observed using the minimum bit-depth in the experiments.
For instance, using 18 bits to quantize the geometry positions of a bicycle, the relative difference is given by:

$$D = 100 \times \frac{22.20958 - 22.14565}{22.20958 - 12.50294} \% ≅ 0.66 \% .$$

For example, the raw model is rendered with unquantized geometry quantization, which is the reference for the highest quality. The rendering is compared with a ground truth image, which results in the highest achievable PSNR. After the input model is rendered, it is also able to be compared with a ground truth image, which results in another PSNR. The PSNR based on the input model is compared with the PSNR of the raw model, and that results in the relative difference, D.

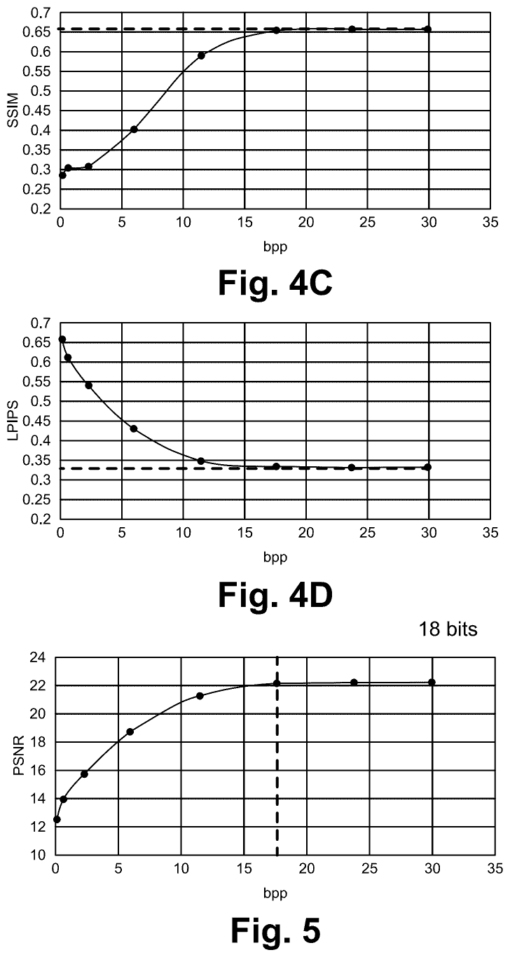

The optimal xyz position bit-depth for a given Gaussian splat is here defined as the one that achieves the highest D under 1%, which in the previous example happens at 18-bit voxelization for xyz positions, as shown in FIG. 5.

The same optimization procedure can be applied sequentially to scales and rotations. A possible pre-processing configuration is: to use an optimal bit-depth for xyz positions per sequence, calculated as described before; and to use a default n-bit (e.g., 8-bit) quantization for all scale and rotation components.

By performing the pre-processing in a manner such that the relative difference between the raw model and the input model is less than 1%, it is ensured that the input model will be sufficiently similar to the raw model.

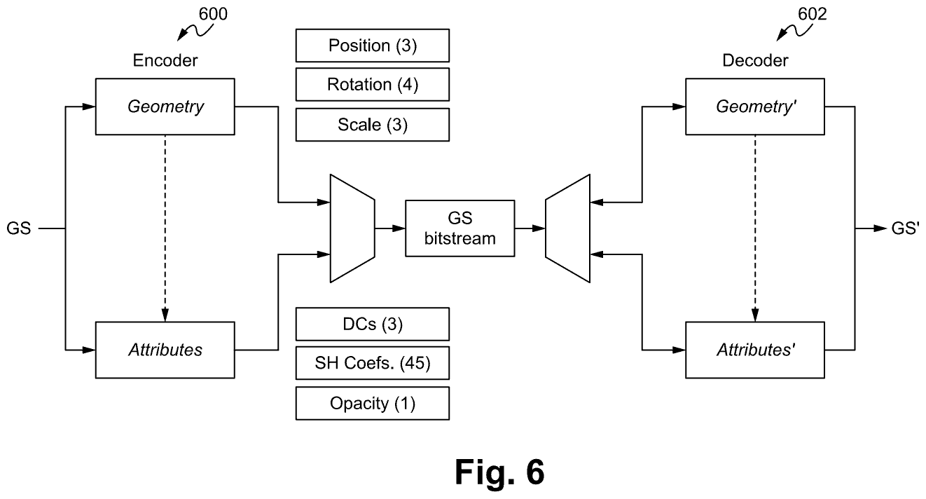

FIG. 6 shows a diagram of a general codec framework according to some embodiments. A Gaussian splat is received at an encoder 600. The parameters of the Gaussian splat are separated such that geometry parameters include position, rotation and scale, and attribute parameters include DCs, SH coefficients and opacity. The pre-processing of the geometry parameters occurs as described, which is input into the geometry encoder for encoding and reconstruction. After the geometry encoding and reconstruction, the attribute encoding occurs. The Gaussian splat bitstream is transmitted to a decoder 602 which reverses the process to reconstruct a substantially similar Gaussian splat.

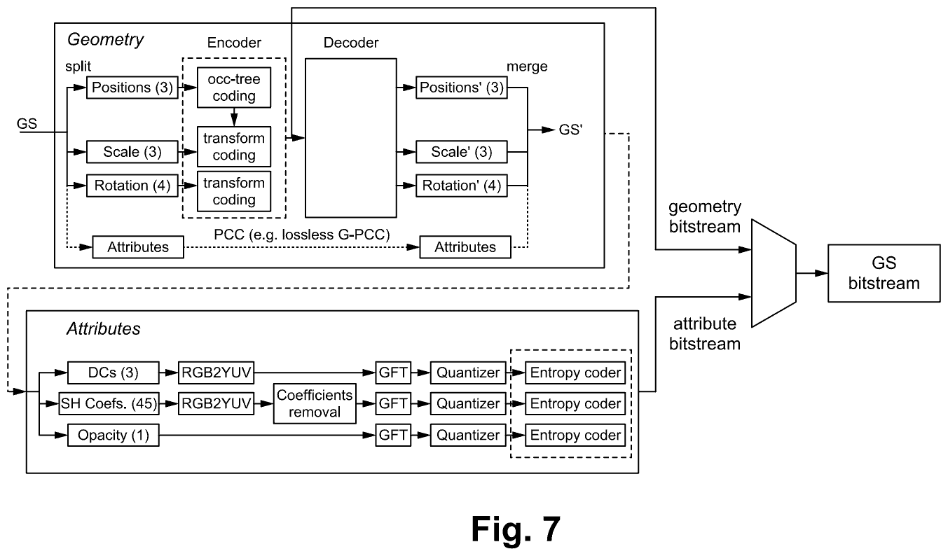

FIG. 7 shows a diagram of a geometry encoder and an attribute encoder according to some embodiments. Pre-processing occurs on the Gaussian splat to obtain the optimal positions, scale and rotation. For the xyz positions, an occupancy tree encoder implements a geometry coding tool such as PCC (e.g., lossless G-PCC). Additionally, for the scale and rotation, transform coding is implemented. The process is reversed to reconstruct a substantially similar Gaussian splat. After the geometry encoding is performed, attribute encoding is implemented. The attributes are transferred to the reconstructed geometry.

In the described framework, geometry coding is performed using point cloud coding techniques. Different point cloud coding configurations are possible. G-PCC geometry coding is used to encode xyz locations (e.g., lossless coding of xyz positions using occupancy tree). G-PCC attribute coding is used to encode scales and rotations. These parameters are mapped into G-PCCs attribute channels and encoded using its attribute coding capabilities (e.g., lossless coding of scales and rotation parameters using lossless predicting-lifting (predlift) transform). The advantage of using lossless coding for geometry is that: it represents only 10 out of 59 total parameters of the 3D Gaussian representation (17% of the data) and a good quality geometry is beneficial to the attribute coding pipeline (83% of the data). However, in alternative embodiments, lossy geometry coding can be applied using a combinations of lossy occupancy tree geometry coding and lossy predlift or RAHT transform coding. AI-based point cloud coding strategies can also be applied.

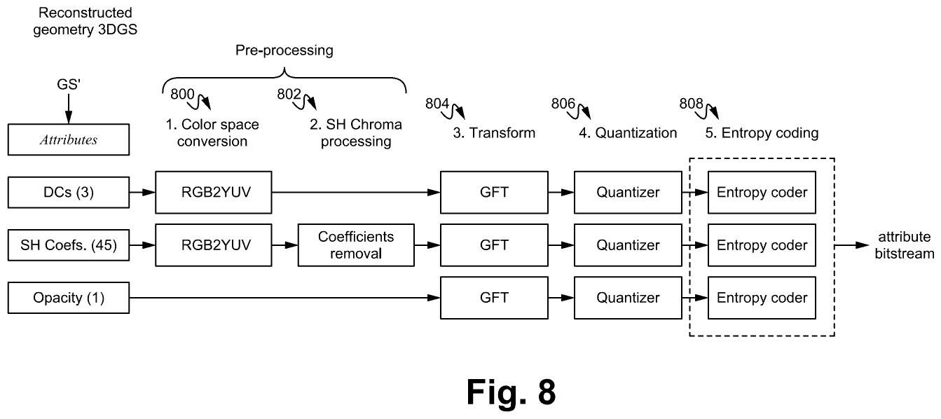

FIG. 8 shows a diagram of attribute coding according to some embodiments. The reconstructed geometry is received after it is processed. The attributes are pre-processed. Pre-processing includes converting the color space for the DCs and SH Coefficients, in the step 800. For example, coefficients are converted from RGB to YUV to decorrelate color channels. Pre-processing also includes coefficient removal (by removing coefficients from the Chroma channels leaving only coefficients from the Luma channel), in the step 802.

In the step 804, graph Fourier transforms are applied to the coefficients. As described herein, applying the graph Fourier transforms to the coefficients generates transform coefficients.

In the step 806, the graph Fourier transform coefficients are quantized for rate control.

In the step 808, the quantized coefficients are entropy coded. Any entropy coder is able to be utilized (e.g., G-PCC entropy coder).

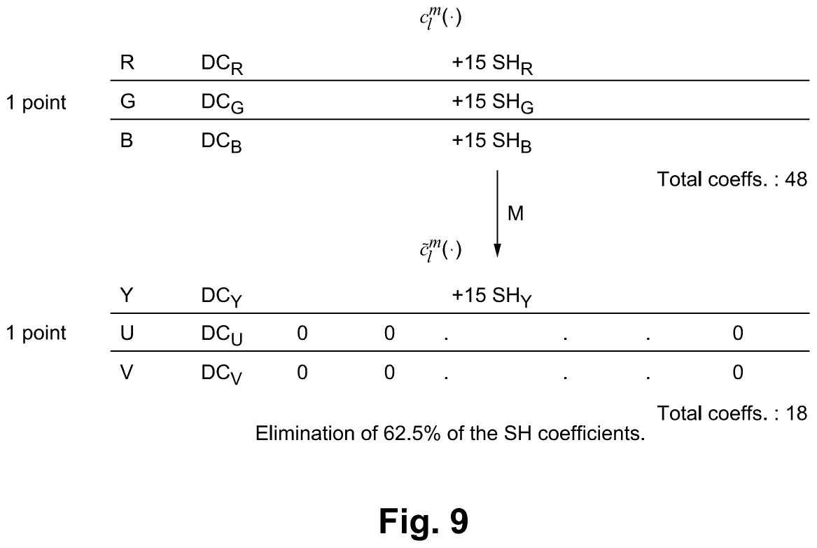

FIG. 9 shows a diagram of reducing the number of SH coefficients according to some embodiments. As shown, the total number of coefficients is reduced from 48 to 18. The 48 dimension vector is divided by three vectors of 16 dimensions each. Each vector includes a representation of Red, Green and Blue. An RGB to YUV transform is applied which results in the YUV channels. All of the coefficients from the Luma channel are preserved, but the coefficients from the Chroma channel are removed. The DC coefficients from each channel are preserved.

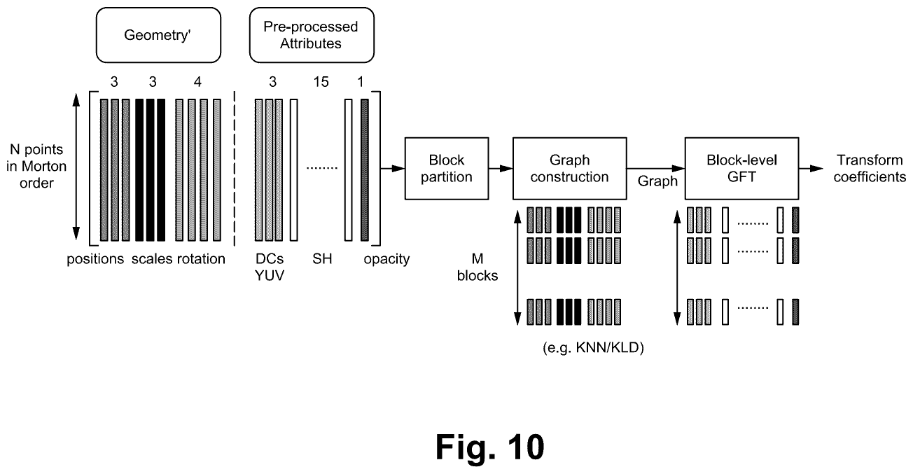

FIG. 10 shows a diagram of transforms according to some embodiments. Positions, scales and rotations information is received from the decoder. The points are sorted in Morton order. Similarly, the pre-processed attributes (DCs, SH, opacity) are sorted in Morton order. Block partitioning based on the geometry is implemented based on the Morton ordered decoded geometry. Block partitioning results in M blocks. For each block, a graph (e.g., KNN/KLD) is constructed. Once there is a graph for each block, a block-level graph Fourier transform is applied, which generates transform coefficients.

One way to construct the graph is to use only x, y, z positions into account. The distance between the points is taken into consideration, and then points that are farther away from each other receive smaller edge weights, and points that are closer to each other receive larger edge weights.

In 3DGS, a set of multivariate (3D) Gaussian distributions are considered:

$${q}_{1} , {q}_{2} , … {q}_{N}$$

where, qᵢ˜ [symbol] (μᵢ, Σᵢ)

$$KL ( {q}_{i} \vert {q}_{j} ) = \frac{1}{2} [ log \frac{\vert {\sum }_{i} \vert}{\vert {\sum }_{j} \vert} + Tr ( {\sum }_{i}^{- 1} {\sum }_{j} ) + {( {μ}_{i} - {μ}_{j} )}^{T} {\sum }_{i}^{- 1} ( {μ}_{i} - {μ}_{j} ) - ]$$

But KL divergence is not symmetric: KL(qᵢ|qⱼ)≠KL(qⱼ|qᵢ). To enforce symmetry for the edge weights of the graph, the following can be applied:
Jefferey's divergence: Twice the arithmetic mean of original KLDs

$$J ( {q}_{i} \vert {q}_{j} ) := KL ( {q}_{i} \vert {q}_{j} ) + KL ( {q}_{j} \vert {q}_{i} )$$

Resistor average divergence: Harmonic mean of original KLDs

$$\frac{1}{R ( {q}_{i} \vert {q}_{j} )} = \frac{1}{2} ( \frac{1}{KL ( {q}_{i} \vert {q}_{j} )} + \frac{1}{KL ( {q}_{j} \vert {q}_{i} )} )$$

Once symmetrized, the weight is:

$${w}_{ij} = {e}^{- \frac{symKL ( {q}_{i} \vert {q}_{j} )}{2 {σ}^{2}}} .$$

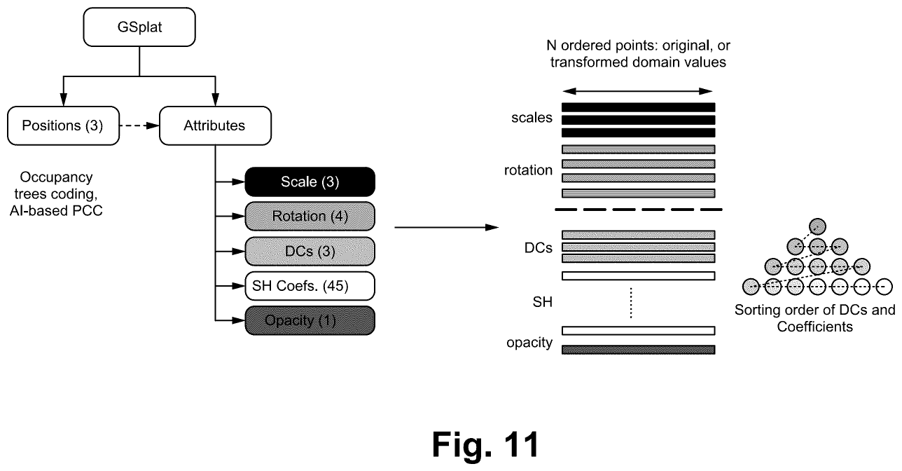

FIG. 11 illustrates a diagram of an image-based approach according to some embodiments. In alternative embodiments, positions are encoded using occupancy trees, such as in G-PCC or AI-based PCC methods, and any subset of attributes of the transformed coefficients of attributes can be mapped into 2D frames and encoded by video coders.

The points are organized (e.g., sorted in a Morton order). The values of the attributes are organized into columns such that each column represents the values of each point (e.g., scales, rotation, DCs, SH, and opacity). For each point, the point is represented as a column in a 2D image which is then input into a video encoder.

As long as a Gaussian splat is viewed as a point cloud, any point cloud-based method is able to be used (e.g., geometry-based, video-based, AI-based).

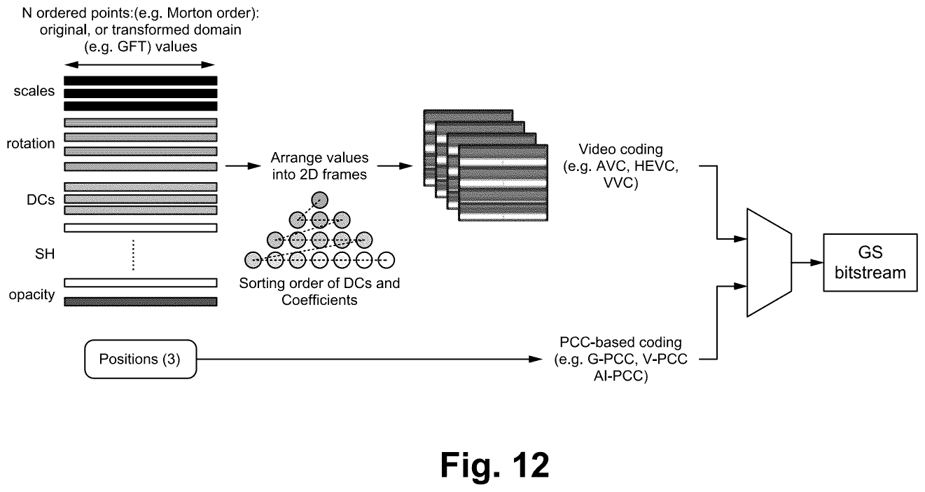

FIG. 12 illustrates a diagram of an image-based approach according to some embodiments. As described, the values of parameters of N ordered points (e.g., Morton order) are in columns, where there is a column for each point. The rows include attributes such as scales, rotations, DCs, SH coefficients and opacity. The columns and rows of information are contained in a 2D structure. The 2D structure is able to be broken down into sub-structures. For example, the values are arranged in 2D frames which are able to be processed using any video coding scheme such as AVC, HEVC, or VVC. For the positions, any PCC-based coding is able to be used (e.g., G-PCC, V-PCC, AI-PCC). The encoded information results in the Gaussian splat bitstream.

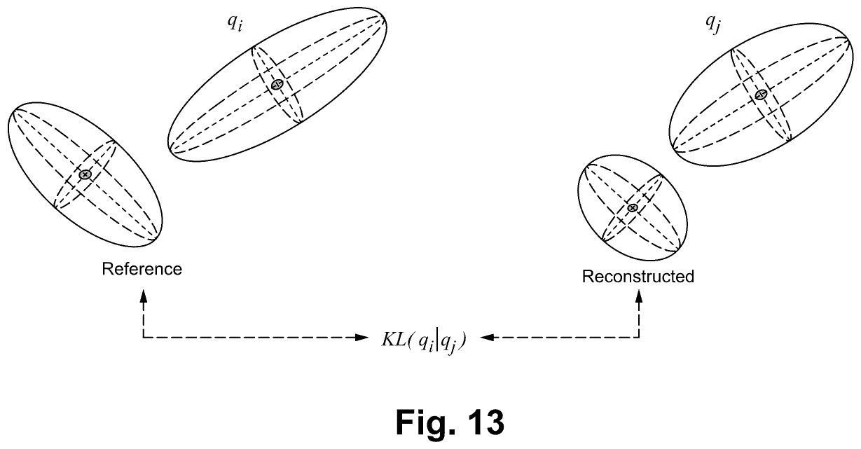

FIG. 13 illustrates a diagram of a 3D Gaussian-based method of distortion evaluation according to some embodiments. The distance between points is not just the location of the center of the Guassian, the evaluation takes into consideration the shape of the Gaussian. KL-Divergence and Wasserstein-based distance can be used.

Similar to KL-divergence, the Wasserstein-2 distance W₂ can also be used to compare the similarity between Gaussian splats, considering positions, quaternions and scales jointly. In contrast to KL-divergence, it intrinsically presents symmetric properties. Closed-form expression:

If q; = [symbol] mᵢ, Σᵢ) and qⱼ= [symbol] (mⱼ, Σⱼ) are two Gaussian distributions, then

$${W}_{2}^{2} ( {q}_{i} , {q}_{j} ) = {‖ {m}_{i} - {m}_{j} ‖}^{2} + Tr ( {\sum }_{i} + {\sum }_{j} - 2 {( {\sum }_{j}^{1 / 2} {\sum }_{i} {\sum }_{j}^{1 / 2} )}^{1 / 2} )$$

mᵢ, mⱼ: Vectors representing the means (centers) of the distributions qᵢ and qⱼ.
Σᵢ, Σⱼ: The covariance matrices, representing the spread and shape of the distributions.
Tr(·): The trace of a matrix.

The MSE_{W} distance between two sets of Gaussian distributions can be computed by applying the Wasserstein distance to all pairs of distributions, as defined by the following equation:

$${MSE}_{W} = max \{ \frac{1}{\vert A \vert} {\sum }_{i ∈ A} {‖ {m}_{i} - {m}_{{j}_{i}} ‖}_{2}^{2} + Tr ( {\sum }_{i} + {\sum }_{{j}_{i}} - 2 {( {\sum }_{i}^{1 / 2} {\sum }_{{j}_{i}} {\sum }_{i}^{1 / 2} )}^{1 / 2} ) , \text{} \frac{1}{\vert B \vert} {\sum }_{j ∈ B} {‖ {m}_{j} - {m}_{{i}_{j}} ‖}_{2}^{2} + Tr ( {\sum }_{j} + {\sum }_{{i}_{j}} - 2 {( {\sum }_{j}^{1 / 2} {\sum }_{{i}_{j}} {\sum }_{j}^{1 / 2} )}^{1 / 2} ) \}$$

A, B: two sets of Gaussian distributions, where qᵢ∈A, qⱼ∈B.
   |A|, |B|: number of elements in each set.
mᵢ, Σᵢ: mean and covariance of distribution qᵢ∈A.
mⱼᵢ, Σⱼᵢ: mean and covariance of the closest distribution qⱼᵢ∈B, matched to qᵢ.
mⱼ, Σⱼ: mean and covariance of distribution qⱼ∈B.
mᵢⱼ, Σᵢⱼ: mean and covariance of the closest distribution qᵢⱼ∈A, matched to qⱼ.

[symbol]

In a comparison against D1 distance metric:
Sample size: reference Gaussian splat=567724, reconstructed Gaussian splat=363254. Instead of all-pair distances: for each query, find k-nearest neighbors by simple mean distance, D1, and compute Wasserstein distances only with the top-k candidates.

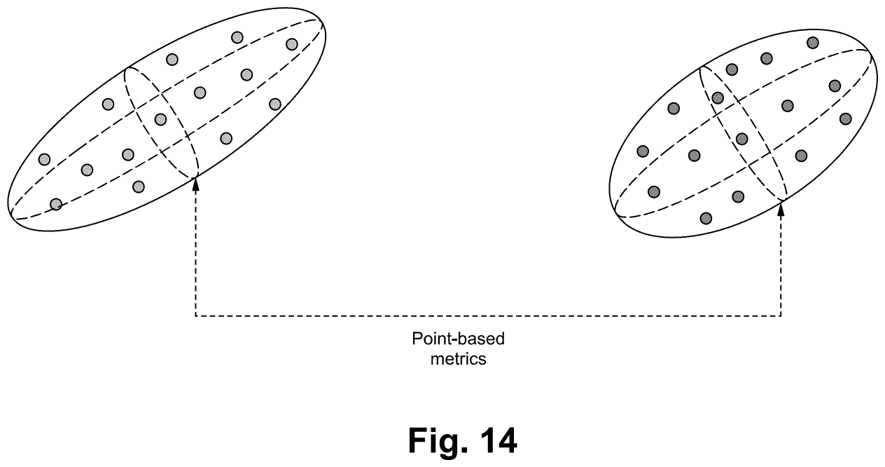

FIG. 14 illustrates a diagram of a 3D Gaussian-based method of evaluation according to some embodiments. A point-based metric is able to be used for distortion evaluation. For example, the surface of the Gaussian is sampled, and the multiple points in the sample are used for reference to compute distortion.

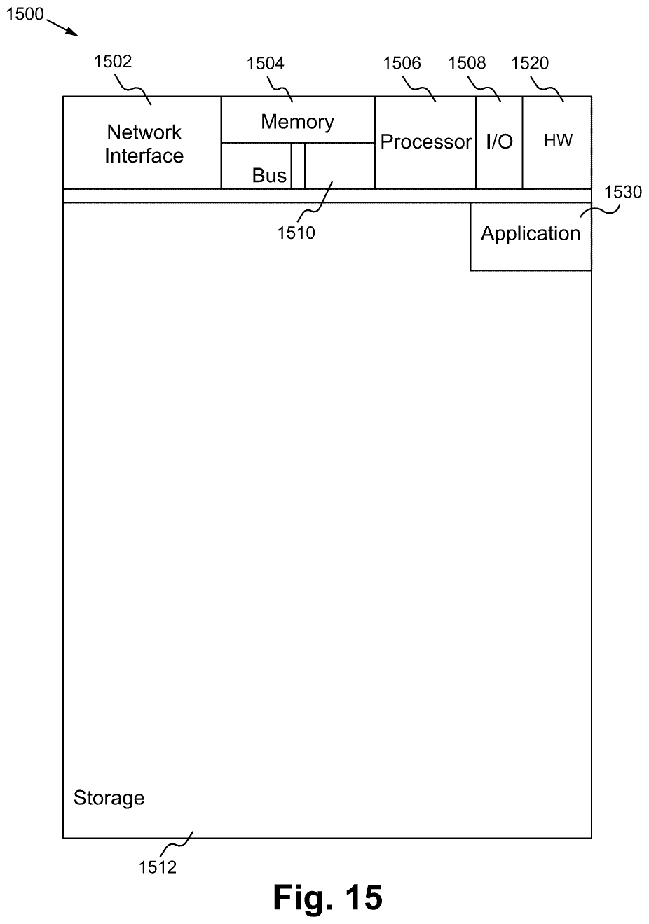

FIG. 15 shows a block diagram of an exemplary computing device configured to implement the 3D Gaussian splatting data compression method according to some embodiments. The computing device 1500 is able to be used to acquire, store, compute, process, communicate and/or display information such as images and videos. The computing device 1500 is able to implement any of the 3D Gaussian splatting data compression method aspects. In general, a hardware structure suitable for implementing the computing device 1500 includes a network interface 1502, a memory 1504, a processor 1506, I/O device(s) 1508, a bus 1510 and a storage device 1512. The choice of processor is not critical as long as a suitable processor with sufficient speed is chosen. The memory 1504 is able to be any conventional computer memory known in the art. The storage device 1512 is able to include a hard drive, CDROM, CDRW, DVD, DVDRW, High Definition disc/drive, ultra-HD drive, flash memory card or any other storage device. The computing device 1500 is able to include one or more network interfaces 1502. An example of a network interface includes a network card connected to an Ethernet or other type of LAN. The I/O device(s) 1508 are able to include one or more of the following: keyboard, mouse, monitor, screen, printer, modem, touchscreen, button interface and other devices. 3D Gaussian splatting data compression application(s) 1530 used to implement the 3D Gaussian splatting data compression method are likely to be stored in the storage device 1512 and memory 1504 and processed as applications are typically processed. More or fewer components shown in FIG. 15 are able to be included in the computing device 1500. In some embodiments, 3D Gaussian splatting data compression hardware 1520 is included. Although the computing device 1500 in FIG. 15 includes applications 1530 and hardware 1520 for the 3D Gaussian splatting data compression method, the 3D Gaussian splatting data compression method is able to be implemented on a computing device in hardware, firmware, software or any combination thereof. For example, in some embodiments, the 3D Gaussian splatting data compression applications 1530 are programmed in a memory and executed using a processor. In another example, in some embodiments, the 3D Gaussian splatting data compression hardware 1520 is programmed hardware logic including gates specifically designed to implement the 3D Gaussian splatting data compression method.

In some embodiments, the 3D Gaussian splatting data compression application(s) 1530 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, an augmented reality device, a virtual reality device, smart jewelry (e.g., smart watch), a vehicle (e.g., a self-driving vehicle) or any other suitable computing device.

To utilize the 3D Gaussian splatting data compression method described herein, devices such as a camera or camera phone are used to acquire content. The 3D Gaussian splatting data compression method is able to be implemented with user involvement or automatically without user involvement.

In operation, the 3D Gaussian splatting data compression method provides many benefits. Experimental results show 10× compression with negligible loss in rendering quality. The codec is competitive with the existing training-based model simplification algorithms and G-PCC-based solutions (for the highest bitrate).

In an alternative embodiment, positions can be encoded using occupancy trees, such as in G-PCC, and any subset of attributes or the transformed coefficients of attributes can be mapped into 2D frames and encoded using video coders.

The techniques described can be extended to time-varying 3D Gaussian Splatting data.

### Some Embodiments of 3D Gaussian Splatting Data Compression

1. A method programmed in a non-transitory memory of a device comprising:
performing compression on a three-dimensional Gaussian splat (3DGS) geometry using a geometry-based point cloud compression (G-PCC) framework;
encoding scales and rotations as attributes using transform coding;
compressing positions using occupancy tree encoding;
implementing block-based graph Fourier transform (GFT) to compress the attributes; and
computing the edge weights based on a similarity between the 3D gaussian distributions using KL-divergence.

2. The method of clause 1 wherein the 3DGS geometry includes positions, the scales, and the rotations.

3. The method of clause 1 wherein the attributes include base colors, spherical harmonics coefficients and opacities.

4. The method of clause 1 wherein the compression is lossless.

5. The method of clause 1 wherein the compression is lossy.

6. The method of clause 1 further comprising pre-processing the 3DGS geometry including performing color space conversion and spherical harmonics coefficients reduction.

7. An apparatus comprising:
a non-transitory memory configured for storing an application, the application configured for:
   performing compression on a three-dimensional Gaussian splat (3DGS) geometry using a geometry-based point cloud compression (G-PCC) framework;
   encoding scales and rotations as attributes using transform coding;
   compressing positions using occupancy tree encoding;
   implementing block-based graph Fourier transform (GFT) to compress the attributes; and
   computing the edge weights based on a similarity between the 3D gaussian distributions using KL-divergence; and
a processor configured for processing the application.

8. The apparatus of clause 7 wherein the 3DGS geometry includes positions, the scales, and the rotations.

9. The apparatus of clause 7 wherein the attributes include base colors, spherical harmonics coefficients and opacities.

10. The apparatus of clause 7 wherein the compression is lossless.

11. The apparatus of clause 7 wherein the compression is lossy.

12. The apparatus of clause 7 wherein the application is further configured for: pre-processing the 3DGS geometry including performing color space conversion and spherical harmonics coefficients reduction.

13. A system comprising:
an encoder configured for:
   performing compression on a three-dimensional Gaussian splat (3DGS) geometry using a geometry-based point cloud compression (G-PCC) framework;
   encoding scales and rotations as attributes using transform coding;
   compressing positions using occupancy tree encoding;
   implementing block-based graph Fourier transform (GFT) to compress the attributes; and
   computing the edge weights based on a similarity between the 3D gaussian distributions using KL-divergence; and
a decoder configured for:
   decoding the compressed Gaussian splat.

14. The system of clause 13 wherein the 3DGS geometry includes positions, the scales, and the rotations.

15. The system of clause 13 wherein the attributes include base colors, spherical harmonics coefficients and opacities.

16. The system of clause 13 wherein the compression is lossless.

17. The system of clause 13 wherein the compression is lossy.

18. The system of clause 13 wherein the encoder is further configured for pre-processing the 3DGS geometry including performing color space conversion and spherical harmonics coefficients reduction.

19. A method programmed in a non-transitory memory of a device comprising:
organizing parameters of a plurality of ordered points;
storing the plurality of ordered points in a two-dimensional structure, wherein each point of the plurality of ordered points is in a column, and attribute information is stored in each row; and
processing the plurality of ordered points and the corresponding attribute information using a video coding scheme;
processing position information using a point cloud coding-based scheme, wherein the processed attribute information and position information generates a Gaussian splat bitstream.

20. The method of clause 19 wherein the plurality of ordered points are ordered in Morton order.

21. The method of clause 19 wherein the attribute information comprises scales, rotations, DCs, spherical harmonics coefficients, and opacity.

22. The method of clause 19 further comprising separating the 2D structure into two or more sub-structures.

23. The method of clause 19 wherein the video coding scheme is selected from Advanced Video Coding, High Efficiency Video Coding or Versatile Video Coding.

24. The method of clause 19 wherein the point cloud coding-based scheme is selected from geometry-based point cloud compression, video-based point cloud compression or artificial intelligence-based point cloud compression.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
performing compression on a three-dimensional Gaussian splat (3DGS) geometry using a geometry-based point cloud compression (G-PCC) framework;
encoding scales and rotations as attributes using transform coding;
compressing positions using occupancy tree encoding;
implementing block-based graph Fourier transform (GFT) to compress the attributes; and
computing the edge weights based on a similarity between the 3D gaussian distributions using KL-divergence.

2. The method of claim 1 wherein the 3DGS geometry includes positions, the scales, and the rotations.

3. The method of claim 1 wherein the attributes include base colors, spherical harmonics coefficients and opacities.

4. The method of claim 1 wherein the compression is lossless.

5. The method of claim 1 wherein the compression is lossy.

6. The method of claim 1 further comprising pre-processing the 3DGS geometry including performing color space conversion and spherical harmonics coefficients reduction.

7. An apparatus comprising:
a non-transitory memory configured for storing an application, the application configured for:
performing compression on a three-dimensional Gaussian splat (3DGS) geometry using a geometry-based point cloud compression (G-PCC) framework;
encoding scales and rotations as attributes using transform coding;
compressing positions using occupancy tree encoding;
implementing block-based graph Fourier transform (GFT) to compress the attributes; and
computing the edge weights based on a similarity between the 3D gaussian distributions using KL-divergence; and
a processor configured for processing the application.

8. The apparatus of claim 7 wherein the 3DGS geometry includes positions, the scales, and the rotations.

9. The apparatus of claim 7 wherein the attributes include base colors, spherical harmonics coefficients and opacities.

10. The apparatus of claim 7 wherein the compression is lossless.

11. The apparatus of claim 7 wherein the compression is lossy.

12. The apparatus of claim 7 wherein the application is further configured for: pre-processing the 3DGS geometry including performing color space conversion and spherical harmonics coefficients reduction.

13. A system comprising:
an encoder configured for:
performing compression on a three-dimensional Gaussian splat (3DGS) geometry using a geometry-based point cloud compression (G-PCC) framework;
encoding scales and rotations as attributes using transform coding;
compressing positions using occupancy tree encoding;
implementing block-based graph Fourier transform (GFT) to compress the attributes; and
computing the edge weights based on a similarity between the 3D gaussian distributions using KL-divergence; and
a decoder configured for:
decoding the compressed Gaussian splat.

14. The system of claim 13 wherein the 3DGS geometry includes positions, the scales, and the rotations.

15. The system of claim 13 wherein the attributes include base colors, spherical harmonics coefficients and opacities.

16. The system of claim 13 wherein the compression is lossless.

17. The system of claim 13 wherein the compression is lossy.

18. The system of claim 13 wherein the encoder is further configured for pre-processing the 3DGS geometry including performing color space conversion and spherical harmonics coefficients reduction.

19. A method programmed in a non-transitory memory of a device comprising:
organizing parameters of a plurality of ordered points;
storing the plurality of ordered points in a two-dimensional structure, wherein each point of the plurality of ordered points is in a column, and attribute information is stored in each row; and
processing the plurality of ordered points and the corresponding attribute information using a video coding scheme;
processing position information using a point cloud coding-based scheme, wherein the processed attribute information and position information generates a Gaussian splat bitstream.

20. The method of claim 19 wherein the plurality of ordered points are ordered in Morton order.

21. The method of claim 19 wherein the attribute information comprises scales, rotations, DCs, spherical harmonics coefficients, and opacity.

22. The method of claim 19 further comprising separating the 2D structure into two or more sub-structures.

23. The method of claim 19 wherein the video coding scheme is selected from Advanced Video Coding, High Efficiency Video Coding or Versatile Video Coding.

24. The method of claim 19 wherein the point cloud coding-based scheme is selected from geometry-based point cloud compression, video-based point cloud compression or artificial intelligence-based point cloud compression.
